(19) United States
(12) Patent Application Publication
(10) Pub. No.: US 2012/0231860 A1
(43) Pub. Date: Sep. 13, 2012

(54) ANTENNA ARRANGEMENT AND PORTABLE RADIO COMMUNICATION DEVICE THEREFORE

(76) Inventors: Andrei Kaikkonen, Jarfalla (SE); Peter Lindberg, Uppsala (SE); Stefan Irmscher, Taby (SE)

(21) Appl. No.: 13/474,902

(22) Filed: May 18, 2012

Related U.S. Application Data
(63) Continuation of application No. PCT/EP2009/067363, filed on Dec. 17, 2009.

(51) Int. Cl. H04B 1/18

(52) U.S. Cl. 455/575.7

(57) ABSTRACT

An exemplary embodiment includes an antenna arrangement for a portable radio communication device comprising at least a first radiating element and a ground plane means. The antenna arrangement comprises a first conductor, which first conductor in a first point is electrically connected to the ground plane means through a high pass filter means and in a first end is open ended. A second end of the first conductor is connected to a FM receiver, FM transmitter, or FM transceiver.

### CROSS-REFERENCE TO RELATED APPLICATION

This application is a continuation of PCT International Application No. PCT/EP2009/067363 filed Dec. 17, 2009, published as WO2011/072740. The entire disclosure of the above application is incorporated herein by reference.

### FIELD

The present disclosure relates to antenna arrangements for portable radio communication devices.

### BACKGROUND

This section provides background information related to the present disclosure which is not necessarily prior art.

A trend for portable radio communication devices, such as mobile phones and similar devices, is to provide devices with multiple band coverage, covering, e.g., FM radio, GSM850, GSM900, GSM1800, GSM1900, UMTS 2100 MHz, GPS, BT and WLAN 2.4 GHz. The limited available space in, e.g., a mobile phone puts restrictions on the design of an antenna therefore. There is thus a constant drive in the art to efficiently utilize available space in portable radio communication devices, e.g., antenna arrangements.

### SUMMARY

This section provides a general summary of the disclosure, and is not a comprehensive disclosure of its full scope or all of its features.

Exemplary embodiments are disclosed of antenna arrangements for portable radio communication devices. Also disclosed are exemplary embodiments of portable radio communication devices including such antenna arrangements.

An exemplary embodiment includes an antenna arrangement for a portable radio communication device comprising at least a first radiating element and a ground plane means. The antenna arrangement comprises a first conductor, which first conductor in a first point is electrically connected to the ground plane means through a high pass filter means and in a first end is open ended. A second end of the first conductor is connected to a FM receiver, FM transmitter, or FM transceiver.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an antenna arrangement according to a first exemplary embodiment.

FIG. 2 is a schematic illustration of an antenna arrangement according to a second exemplary embodiment.

FIG. 3 is a schematic illustration of an antenna arrangement according to a third exemplary embodiment.

FIG. 4 is a schematic illustration of an antenna arrangement according to a fourth exemplary embodiment.

### DETAILED DESCRIPTION

Example embodiments will now be described more fully with reference to the accompanying drawings

The inventors hereof have recognized the following in regard to antenna arrangements for portable radio communication devices. The bandwidth of an antenna arrangement varies with the length of the ground plane means. A common length for the ground plane means in modern cellular phones is around 100 millimeters (mm). This length is set by a number of factors, such as a comfortable length for handling the mobile device such that the mobile device should sit well in the palm of a user and having enough room for electronic components in the mobile device, etc. Unfortunately, the bandwidth for the 2 Gigahertz (GHz) frequency band has a bandwidth minimum for a length of approximately 100 millimeters of the ground plane means.

By providing the ground plane means with wave traps at an end opposite the end in which a radiating element of the antenna arrangement is positioned, the electrical length of the ground plane means as perceived by the radiating element can be adjusted to thereby increase the bandwidth of the antenna arrangement. An alternative way of increasing the bandwidth of an antenna arrangement is to provide a radiating element of the antenna arrangement with a parasitic radiating element. After recognizing the above, the inventors hereof have developed and disclose antenna arrangements with further frequency band coverage with utilizing of an available conductor.

According to an exemplary aspect of the present disclosure, there is disclosed an exemplary embodiment of an antenna arrangement for a portable radio communication device comprising at least a first radiating element and a ground plane means. The antenna arrangement includes a first conductor, which first conductor in a first point is electrically connected to the ground plane means through a high pass filter means. The first conductor has a first end that is open ended. A second end of the first conductor is connected to a FM receiver or FM transmitter. In this exemplary way, an antenna arrangement covering, e.g., GSM1800-1900 can be provided that also provides FM coverage utilizing an available conductor in an efficient way.

According to a preferred aspect of the present disclosure, the first radiating element is provided at a first end of the ground plane means. The antenna arrangement comprises a wave trap provided at a second end of the ground plane means, wherein the second end is located opposite to the first end of the ground plane means. The wave trap comprises the first conductor, and which wave trap extends in a general direction towards the first end of the ground plane means.

In this example, the wave trap is positioned at an opposite end to an antenna radiating means and connected to the ground plane, such that the wave trap will shorten the electrical length of the ground plane means. In turn, the electrical length of the ground plane means as perceived by the antenna radiating means is not equal to a minimum in the relationship between bandwidth and the length of the ground plane means for some specified frequency. Thus, the bandwidth is increased.

Advantageously, the open end of the first conductor ends a half of a wavelength from the first end of the ground plane means. In this exemplary way, bandwidth minimum is not only avoided, but bandwidth maximum may also be achieved. Preferably, the first radiating element is configured to send and receive RF-signals in at least 1800-1900 Megahertz (MHz). Also, the first conductor preferably has an electrical length between the first open end and the first point of a quarter of the wavelength of 1800-1900 MHz.

For an improved wave trap, the wave trap preferably comprises a second conductor having a first end electrically connected to the second end of the first conductor. The second conductor preferably is open ended in a second end and extends in a general direction towards the first end of the ground plane means. The open ends of the first and second conductors are preferably located at opposite sides of the ground plane means.

By providing the first conductor as a conductive wire positioned over the ground plane means, a cheap and robust solution is provided. Advantageously, the FM receiver or FM transmitter is a FM transceiver in some exemplary embodiments. For improved FM operation, the FM receiver is preferably connected to the second end of the first conductor through FM matching means. The FM matching means is advantageously a grounded inductor, and the high pass filter means is advantageously a capacitor.

An exemplary embodiment of the antenna arrangement comprises a parasitic radiating element comprising the first conductor. The first radiating element is preferably configured to send and receive RF-signals in at least 850-900 MHz. The first conductor preferably or advantageously has an electrical length between the first end and the first point of a quarter of the wavelength of 850-900 MHz.

For efficiently utilization of available space, as well as improved bandwidth, the parasitic radiating element is preferably provided along at least one side edge of the ground plane means. For improved efficiency of the FM antenna, the first conductor is preferably or advantageously arranged along essentially all of the second edge of the ground plane means.

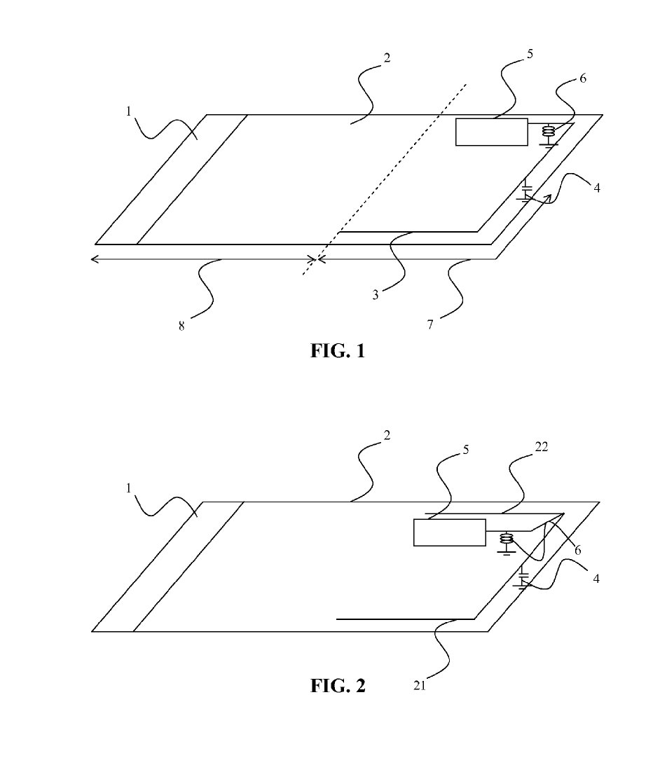

With reference now to the figures, FIG. 1 illustrates an exemplary embodiment of an antenna arrangement for a portable radio communication device. The bandwidth for an antenna arrangement for a portable radio communication device, such as a mobile phone, has a minimum for some specific lengths of the ground plane means depending on the design frequency. For the 2 GHz frequency or 2 GHz frequency band (which roughly corresponds to the third generation standards), the minimum length of the ground plane means is approximately 100 millimeters. Unfortunately, this is also a common length of mobile communication devices, and thereby the ground plane experienced by the radiating devices or antennas provided for receiving and transmitting RF-signals in the frequency bands close to 2 GHz.

A way of preventing, e.g., a mobile phone from exhibiting a bandwidth minimum length at a certain length for radio signalling purposes is to introduce a so called wave trap to shorten the length of the ground plane thereof to not coincide with the bandwidth minimum length. But in mobile communication devices, integration has come very far and every square millimeter thereof is oftentimes occupied with electronics. Therefore, it is not feasible to extend or shorten the factual length of the ground plane. After recognizing this, the inventors hereof developed and disclose herein exemplary embodiments of antenna arrangements including the antenna arrangements illustrated in FIG. 1.

As shown in FIG. 1, the antenna arrangement comprises a first radiating element 1, a ground plane means 2, and a wave trap 3. The first radiating element 1 is positioned at a first end of the ground plane means 2. The wave trap 3 is positioned at a second end of the ground plane means 2. The second end of the ground plane means 2 is located opposite the first end thereof. The antenna arrangement is may be provided in a portable radio communication device, such as a mobile phone, etc.

The first radiating element 1 may be provided completely over, partially over, or at the side of the ground plane means 2. In this illustrated embodiment of FIG. 1, the first radiating element 1 is positioned completely over the ground plane means 2. Furthermore, the first radiating element 1 may be provided as a PIFA, IFA, L-antenna, half-loop, monopole, or any other antenna means which induces radiating currents in the ground plane. In this illustrated embodiment of FIG. 1, the first radiating element 1 is provided as or comprises a PIFA. The first radiating element 1 is typically providing multiple frequency band coverage, such as in this exemplary embodiment covering at least HB GSM (1800-1900 MHz). The ground plane means 2 are most often provided as a part of a printed circuit board (not shown) of the portable radio communication device, but may also be provided by other means, such as a dedicated ground plane. In this exemplary embodiment of FIG. 1, the ground plane means 2 is provided as a part of a printed circuit board.

The wave trap comprises a first conductor 3 that is connected in a first point to the ground plane means 2 through a high pass filter means 4. The first conductor 3 has a first end that is open ended. The connection to the ground plane means 2 is near the edge of the ground plane means 2. The wave trap extends towards the first radiating element 1 at the first end of the ground plane means 2. The open first end of the first conductor 3 ends a distance 8 of half a wavelength of an operating frequency of the first radiating element 1 (which operating frequency in this exemplary embodiment is HB GSM) from the first edge of the ground plane means 2. In this exemplary way, a maximum (or at least increased) bandwidth for this operating frequency is achieved for the antenna arrangement contrary to a minimum bandwidth typically exhibited without a wave trap.

In this exemplary embodiment, the wave trap is configured for maximizing the bandwidth for HB GSM. The first conductor 3 has an electrical length 7 between the first point and the first end of a quarter of a wavelength of the desired operating frequency of the first radiating element 1. In this exemplary way, a high-impedance interface at the first open end is achieved, thereby stopping current flow induced by the desired operating frequency in the wave trap region, isolating a typical speaker region of the portable radio communication device from RF fields, which improves, e.g., HAC (Hearing Aid Compatibility) for the portable radio communication device.

The high pass filter means 4 is preferably provided as capacitor. In this exemplary embodiment, the high pass filter means 4 comprises a 5 picoFarad (pF) capacitor or 10 pF capacitor grounding HB GSM and blocking FM frequencies.

Utilization of the first conductor 3 for simultaneous FM communication is arranged by connecting a second end thereof to a FM receiver or transmitter 5. The FM receiver or transmitter 5 is preferably connected to the second end thereof through FM matching means 6, preferably provided as a grounded inductor. In this exemplary embodiment, the FM matching means 6 comprises a 200 nH (nanoHenry) inductor or 390 nH inductor. The FM receiver or transmitter 5 is alternatively a FM transceiver.

The first conductor 3 is preferably provided as a conductive wiring or wire. The conductive wire preferably extends at the side of the ground plane means 2, in the direction towards the first end of the ground plane means 2. If the space between the conductive wire and the ground plane means 2 is filled with a dielectric, the length of the conductive wire may be shortened. This may affect the electrical impedance, but this may be corrected by adjusting the spacing between the conductive wire and the ground plane means 2. The conductive wire may conveniently be provided in a housing of a mobile device or at any other convenient place.

The wave trap preferably extends for a part along the second end of the ground plane means 2 before it extends further along a side of the ground plane means 2 towards the first radiating means 1. This makes it possible to have a quarter wavelength long wave trap which extends shorter than a quarter wavelength along the side of the ground plane means 2. Preferably, the first conductor 3 extends essentially along all of the second edge of ground plane means 2. This improves the efficiency of the FM antenna.

It should be mentioned that currents will still flow in the ground plane means 2 below the open end of the wave trap. There will be a current minimum at the open end of the wave trap and current maxima at the connection between the wave trap and the ground plane means 2, at the first point of the conductor 3. The currents in the ground plane means 2 below the open end will, however, be in differential mode in relation to the currents in the wave trap and will therefore not radiate.

Although the antenna arrangement has been described having a first radiating element 1 functioning as the main antenna for the antenna arrangement, the antenna arrangement may alternatively comprise a plurality of radiating elements for providing the desired operating frequencies.

FIG. 2 illustrates a second exemplary embodiment of an antenna arrangement for a portable radio communication device. The second embodiment is identical to the first embodiment described above, apart from the following.

As shown in FIG. 2, the wave trap comprises a first conductor 21 and a second conductor 22. Each of the first and second conductors 21, 22 are in a second end thereof connected to the ground plane means 2 through the high pass filter means 4. A first end of each of the first and second conductors 21, 22 is open ended. The first and second conductors 21 and 22 are positioned at opposing sides of the ground plane means 2, thereby more efficiently blocking the wave trap region of the ground plane means 2.

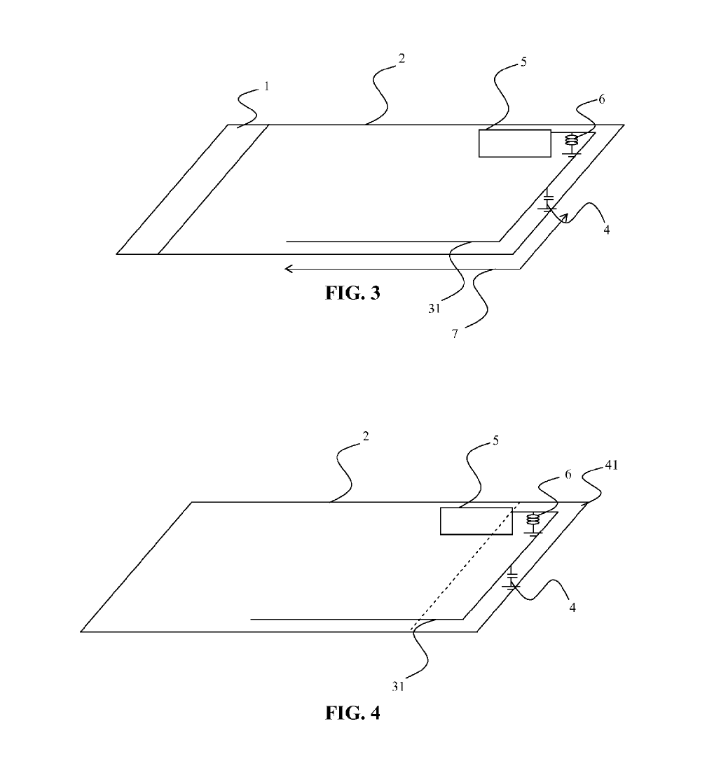

FIG. 3 illustrates a third exemplary embodiment of an antenna arrangement for a portable radio communication device. As shown in FIG. 3, this third exemplary embodiment of the antenna arrangement includes a first radiating element 1, a ground plane means 2, and a first conductor that is a parasitic radiating element 31.

The first radiating element 1 is positioned at a first end of the ground plane means 2. The parasitic radiating element 31 is positioned at a second end of the ground plane means 2. The second end of the ground plane means 2 is located opposite the first end thereof. The antenna arrangement is provided in a portable radio communication device, such as mobile phone, etc.

The first radiating element 1 may be provided completely over, partially over, or at the side of the ground plane means 2. As shown in FIG. 3, the first radiating element 1 in this embodiment is positioned completely over the ground plane means 2. Furthermore, the first radiating element 1 may be provided as a PIFA, IFA, L-antenna, half-loop, monopole, or any other antenna means which induces radiating currents in the ground plane. In this exemplary embodiment, the first radiating element 1 is provided as or comprises a PIFA. The first radiating element 1 is typically providing multiple frequency band coverage, such as in this exemplary embodiment covering at least LB GSM (850-900 MHz). The ground plane means 2 are most often provided as a part of a printed circuit board (not shown) of the portable radio communication device, but may also be provided by other means, such as a dedicated ground plane. In this exemplary embodiment of FIG. 1, the ground plane means 2 is provided as a part of a printed circuit board.

The parasitic radiating element 31 is in a first point connected to the ground plane means 2 through a high pass filter means 4. A first end of the parasitic radiating element 31 is open ended. The connection to the ground plane means 2 is near the edge of the ground plane means 2. The parasitic radiating element 31 extends towards the first radiating element 1 at the first end of the ground plane means 2. The parasitic radiating element 31 has an electrical length between the first point and the first end of a quarter of a wavelength of the desired operating frequency of the first radiating element 1, in this embodiment is LB GSM.

The high pass filter means 4 is preferably provided as capacitor. In this exemplary embodiment, the high pass filter means 4 comprises a 5 picoFarad (pF) capacitor or 10 pF capacitor grounding LB GSM and blocking FM frequencies.

Utilization of the parasitic radiating element 31 for simultaneous FM communication is arranged by connecting a second end thereof to a FM receiver or transmitter 5. The FM receiver or transmitter 5 is preferably connected to the second end thereof through FM matching means 6, preferably provided as a grounded inductor. In this exemplary embodiment, the FM matching means 6 comprises a 200 nH inductor or 390 nH inductor. The FM receiver or transmitter 5 is alternatively a FM transceiver.

The parasitic radiating element 31 is preferably provided as a conductive wiring or wire. The conductive wire preferably extends at the side of the ground plane means 2, in the direction towards the first end of the ground plane means 2. If the space between the conductive wire and the ground plane means 2 is filled with a dielectric, the length of the conductive wire may be shortened. This may affect the electrical impedance, but this may be corrected by adjusting the spacing between the conductive wire and the ground plane means 2. The conductive wire may conveniently be provided in a housing of a mobile device or at any other convenient place.

The parasitic radiating element 31 preferably extends for a part along the second end of the ground plane means 2 before it extends further along a side of the ground plane means 2 towards the first radiating means 1. This makes it possible to have a quarter wavelength long parasitic radiating element which extends shorter than a quarter wavelength along the side of the ground plane means 2. Preferably, the conductor extends essentially along all of the second edge of ground plane means 2. This improves the efficiency of the FM antenna.

Although the antenna arrangement has been described having a first radiating element 1 functioning as the main antenna for the antenna arrangement, the antenna arrangement may alternatively comprise a plurality of radiating elements for providing the desired operating frequencies.

FIG. 4 illustrates a fourth exemplary embodiment of an antenna arrangement for a portable radio communication device. The fourth embodiment is identical to the third embodiment described above, apart from the following. The first radiating element 41 is positioned at the same end of the ground plane means 2 as the parasitic radiating element 31.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna arrangement for a portable radio communication device including at least a first radiating element and a ground plane means, the antenna arrangement comprising a first conductor having a first end that is open ended and a second end, the first conductor in a first point electrically connected to the ground plane means through a high pass filter means, the second end of the first conductor connected to a FM receiver, FM transmitter, or FM transceiver.

2. The antenna arrangement of claim 1, wherein:
the at least a first radiating element is provided at a first end of the ground plane means;
the antenna arrangement further comprises a wave trap provided at a second end of the ground plane means that is opposite to the first end of the ground plane means; and
the wave trap comprises the first conductor and extends in a general direction towards the first end of the ground plane means.

3. The antenna arrangement of claim 2, wherein the first end of the first conductor ends a half of a wavelength of an operating frequency of the first radiating element from the first end of the ground plane means.

4. The antenna arrangement of claim 2, wherein:
the at least a first radiating element is configured to send and receive RF-signals in at least 1800-1900 MHz; and/or
the first conductor has an electrical length between the first point and the first end of a quarter of the wavelength of 1800-1900 MHz.

5. The antenna arrangement of claim 2, wherein:
the wave trap comprises a second conductor having a first end electrically connected to the second end of the first conductor and a second end that is open ended; and
the open ends of the first and second conductors are located at opposite sides of the ground plane means.

6. The antenna arrangement of claim 1, wherein:
the first conductor comprises a conductive wire positioned over the ground plane means; and/or
the at least a first radiating element is configured to send and receive RF-signals in at least 850-900 MHz or 1800-1900 MHz; and/or
the second end of the first conductor is connected to a FM transceiver.

7. The antenna arrangement of claim 1, wherein the second end of the first conductor is connected to a FM receiver, FM transmitter, or FM transceiver through FM matching means.

8. The antenna arrangement of claim 7, wherein the FM matching means comprises a grounded inductor.

9. The antenna arrangement of claim 1, wherein the high pass filter means comprises a capacitor.

10. The antenna arrangement of claim 1, wherein the antenna arrangement comprises a parasitic radiating element comprising the first conductor.

11. The antenna arrangement according to claim 10, wherein:
the at least a first radiating element is configured to send and receive RF-signals in at least 850-900 MHz; and/or
the first conductor has an electrical length between the first point and the first end of a quarter of the wavelength of 850-900 MHz; and/or
the parasitic radiating element is provided along at least one side edge of the ground plane means.

12. The antenna arrangement of claim 1, wherein the first conductor is arranged along at least essentially all of the second edge of the ground plane means.

13. A portable communication device including the at least a first radiating element, the ground plane means, the antenna arrangement of claim 1, and the FM receiver, FM transmitter, or FM transceiver connected to the second end of the first conductor.

14. A portable radio communication device comprising:
a ground plane means having a first end and a second end opposite to the first end;
at least a first radiating element provided at the first end of the ground plane means;
a first conductor having a first end that is open ended and a second end connected to a FM receiver, FM transmitter, or FM transceiver, the first conductor in a first point electrically connected to the ground plane means through a high pass filter means; and
a wave trap provided at the second end of the ground plane means, the wave trap comprising the first conductor and extending in a general direction towards the first end of the ground plane means.

15. The portable radio communication device of claim 14, wherein:
the first end of the first conductor ends a half of a wavelength of an operating frequency of the first radiating element from the first end of the ground plane means; and/or
the at least a first radiating element is configured to send and receive RF-signals in at least 1800-1900 MHz; and/or
the first conductor has an electrical length between the first point and the first end of a quarter of the wavelength of 1800-1900 MHz; and/or
the first conductor is a conductive wire positioned over the ground plane means.

16. The portable radio communication device of claim 14, wherein:
the wave trap comprises a second conductor having a first end electrically connected to the second end of the first conductor and a second end that is open ended; and
the open ends of the first and second conductors are located at opposite sides of the ground plane means.

17. The portable radio communication device of claim 14, wherein:
the second end of the first conductor is connected to a FM receiver, FM transmitter, or FM transceiver through FM matching means comprising a grounded inductor; and/or
the high pass filter means comprises a capacitor.

18. A portable radio communication device comprising:
a ground plane means having a first end and a second end opposite to the first end;
at least a first radiating element provided at the first end of the ground plane means;
a first conductor having a first end that is open ended and a second end connected to a FM receiver, FM transmitter, or FM transceiver, the first conductor in a first point electrically connected to the ground plane means through a high pass filter means; and
a parasitic radiating element comprising the first conductor.

19. The portable radio communication device of claim 18, wherein:
the at least a first radiating element is configured to send and receive RF-signals in at least 850-900 MHz; and/or
the first conductor has an electrical length between the first point and the first end of a quarter of the wavelength of 850-900 MHz; and/or
the parasitic radiating element is provided along at least one side edge of the ground plane means.

20. The portable radio communication device of claim 14, wherein:
the second end of the first conductor is connected to a FM receiver, FM transmitter, or FM transceiver through FM matching means comprising a grounded inductor; and/or
the high pass filter means comprises a capacitor.
